(19) United States
(12) Patent Application Publication
(10) Pub. No.: US 2008/0062560 A1
(43) Pub. Date: Mar. 13, 2008

(54) Scratch effect controller with slippable surface

(75) Inventors: James Mazur, Ft. Lauderdale, FL (US); Alan Flum, Oakland, CA (US)

Correspondence Address: DAY PITNEY LLP, 7 TIMES SQUARE, NEW YORK, NY, 10036-7311, US

(73) Assignee: STANTON MAGNETICS, INC.

(21) Appl. No.: 11/520,397

(22) Filed: Sep. 13, 2006

(51) Int. Cl. G11B 5/82

(52) U.S. Cl. 360/135

(57) ABSTRACT

The disclosure pertains to a scratch effect controller wherein the lower surface of the user manipulated disc and the upper surface of the rotary platter are made of low friction material. The lower surface of the user manipulated disc and the upper surface of the rotary platter impinge against each other creating an area of low friction, thereby eliminating the need for a slip disc.

### BACKGROUND OF THE INVENTION

1. Field of the Invention

The present invention pertains to a scratch effect controller for a disk jockey, or similar application, wherein a low friction surface is provided on the lower face of the user manipulated disc and the upper face of the rotating platter, whereby the two low friction surfaces abut each other.

2. Description of the Prior Art

DJs (disk jockeys) traditionally entertain their audiences by manipulating the speed and direction of a vinyl record used on phonographic turntables to produce various effects including the well known “scratch effect”. The turntable has been replaced by CD players that have turntable like platters that can be turned by the DJ to produce the scratch effect and simulate other characteristics of manipulating a vinyl record on a traditional phonographic turntable. These CD players have evolved to include a rotating platter, a felt, cloth or plastic slip disc, and a user manipulated vinyl record-like surface. The rotating platter can turn at same speed as a traditional turntable, 33, 45 or 78 rpm. The user manipulates the vinyl record-like surface in the same manner that a DJ would manipulate real vinyl. As the DJ moves the vinyl record-like surface, the slip disc allows the user to move the record independently of the rotating platter. Hori teaches a device that consists of an optical disc player, a user manipulated surface and driven rotating surface where there is some type of encoding mechanism to detect the speed and direction of both the user surface and the rotating surface.

The next evolution beyond the moving platter CD player for DJs is the moving platter computer interface control surface. Many DJs desire to use a phonographic turntable-like control surface to manipulate music on their computer. U.S. Pat. No. 6,541,690 entitled “Scratch Effect Controller” to Segers, for example, teaches such a device that manipulates an audio stream on a personal computer using a device that consists of a rotating platter, a user manipulated surface (encoder disc), and a slip disc.

Similarly, U.S. Pat. No. 6,985,418 entitled “Optical Disk Reproducing Apparatus” to Hori teaches a resin coated sheet as a slip disc that lies between the operational surface and the rotating disc.

One problem not addressed by any of the prior art is that an intermediate surface is required to create a fixed amount of friction. On a traditional phonographic turntable, this is required since the user manipulated surface is an actual two-sided phonographic record that contains audio information. In the case of the DJ controller, the user manipulated surface does not contain any audio information; it is strictly an ergonomic control surface that simulates the feel of a phonographic record.

### OBJECTS AND SUMMARY OF THE INVENTION

It is therefore an object of the present invention to provide a scratch effect controller with the appropriate tactile feel for disk jockey, with the appropriate amount of friction, yet without a slip disc between the motor driven rotary platter and the user manipulated disc.

This and other objects are attained by providing a scratch effect controller with a user manipulated disc with a lower surface with reduced friction and a motor driven rotary platter with an upper surface with reduced friction. The two surfaces with reduced friction abut one another and provide a rotary slipping relationship therebetween. These low friction surfaces are provided by Delrin, Teflon (i.e., polytetrafluoroethylene) or a similar substance.

### BRIEF DESCRIPTION OF THE DRAWINGS

Further objects and advantages of the invention will become apparent from the following description and from the accompanying drawings, wherein:

FIG. 1 is a side plan view of the scratch controller of the present invention.

FIG. 2 is a possible embodiment of the encoding pattern on the upper surface of the user manipulated disc.

### DETAILED DESCRIPTION OF THE PREFERRED EMBODIMENT

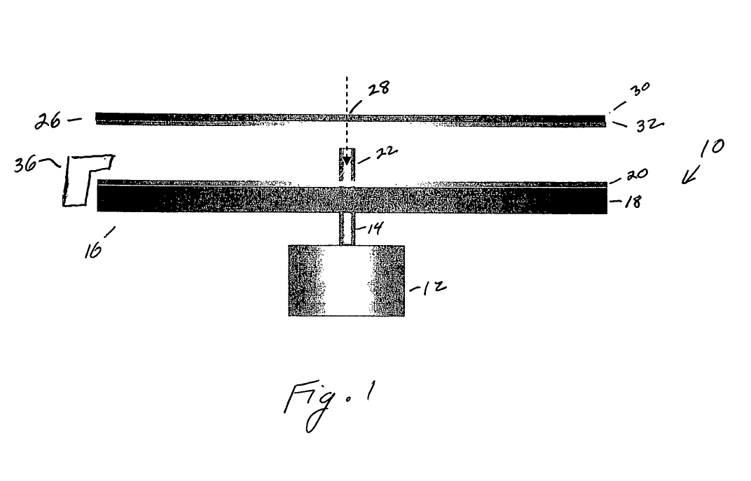

Referring now to the drawing in detail, one sees that FIG. 1 illustrates the scratch controller 10 of the present invention. Motor 12 drives rotary shaft 14 which, in turn, drives rotary platter 16 in concert therewith. Rotary platter 16 includes a lower portion 18 formed of traditional materials for phonographic platters, such as steel, aluminum or plastic. Rotary platter 16 further includes upper surface 20 of low friction material such as Delrin, Teflon (i.e., polytetrafluoroethylene) or a similar substance. Rotary platter 16 further includes upwardly protruding spindle 22 which is co-linear with rotary shaft 14 and rotates in concert therewith.

User manipulated disc 26 is disc-shaped with a central aperture 28 so as to have the shape of a phonograph record. Spindle 22 passes through aperture 22 whereby user manipulated disc 26 is supported by rotary platter 16 in the same manner that a convention phonograph record is supported by a turntable. User manipulated disc 26 includes upper surface 30 which is typically made from vinyl similar to that of phonograph records, or a similar material so as to simulate the feel of a conventional phonograph record on a conventional turntable. User manipulated disc further includes lower surface 32 which is made of low friction material such as Delrin, Teflon (i.e., polytetrafluoroethylene) or a similar substance. Lower surface 32 of user manipulated disc 26 abuts upper surface 20 of rotary platter 16. Therefore, these two surfaces 20, 32 made of low friction material create a particularly low friction area of contact therebetween thereby eliminating the need for a slip disc while maintaining the friction required for a scratch controller.

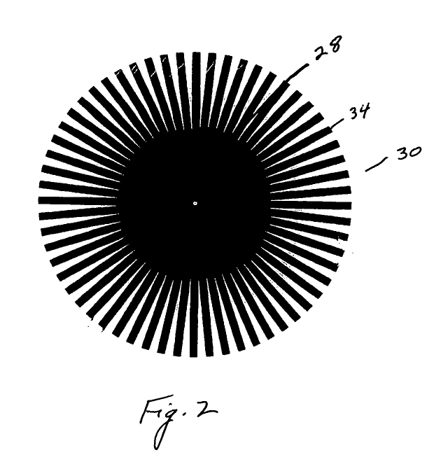

Upper surface 30 of user manipulated disc 26 includes an encoding pattern 34 (see FIG. 2) such as that disclosed in U.S. Pat. No. 6,541,690 entitled “Scratch Effect Controller” issued on Apr. 1, 2003 to Segers, the entire contents of which are hereby incorporated by reference. Those skilled in the art will recognize a broad range of equivalents after review of the present disclosure.

Optical pick up 36 reads the rotating encoding pattern 34 of upper surface 30 of user manipulated disc 26 and transmits the data to a digital system such as that disclosed in the above-identified U.S. Pat. No. 6,541,690 thereby controlling the playback of digitally encoded music in response to the movements of the user manipulated disc 26. Typically, if the user manipulated disc 26 is rotating at the expected (i.e., unimpeded, such as 33, 45 or 78 rpm) rotary speed of rotary platter 16 in the absence of user manipulation of disc 26, the digitally encoded music is played back in ordinary fashion. However, if optical pick up 36 detects user manipulation of disc 26, such as disc 26 moving faster than, slower than, or even in reverse direction from the expected (i.e., unimpeded) rotary speed of rotary platter 16, then the music is played back faster, slower, or in reverse order, respectively, from the ordinary playback. This allows a disk jockey to create scratch effects thereby simulating a user manipulated phonograph record in the playback of digitally recorded music.

Thus the several aforementioned objects and advantages are most effectively attained. Although preferred embodiments of the invention have been disclosed and described in detail herein, it should be understood that this invention is in no sense limited thereby and its scope is to be determined by that of the appended claims.

What is claimed is:

1. A device for producing scratch effects in a digitized audio signal, comprising:
a rotating platter with an upper surface formed of low friction material;
an encoding disc with a lower surface of low friction material and an upper user manipulated surface;
wherein said rotating platter and said encoding disc rotate about a common axis and said upper surface of said rotating platter and said lower surface of said encoding disc abut each other; and
a detector for detecting the rotary speed of said encoding disc.

2. The device of claim 1 wherein said user manipulated surface is formed from a material to simulate a tactile feel of a phonograph record.

3. The device of claim 1 wherein said user manipulated surface is formed from vinyl.

4. The device of claim 1 wherein said lower surface of said encoding disc and said upper surface of said rotating platter are formed from materials chosen from the group consisting of teflon, delrin and polytetrafluoroethylene.
